(19) United States
(12) Patent Application Publication
(10) Pub. No.: US 2018/0208734 A1
(43) Pub. Date: Jul. 26, 2018

(54) MAGNETIC HYDROPHOBIC POROUS GRAPHENE SPONGE FOR ENVIRONMENTAL AND BIOLOGICAL/MEDICAL APPLICATIONS

(71) Applicants: Cengiz S. Ozkan, San Diego, CA (US); Mihrimah Ozkan, San Diego, CA (US); Hamed Hosseini, Arlington, VA (US); Fabian Villalobos, Grand Terrace, CA (US); Andrew Patalano, Moreno Valley, CA (US)

(72) Inventors: Cengiz S. Ozkan, San Diego, CA (US); Mihrimah Ozkan, San Diego, CA (US); Hamed Hosseini, Arlington, VA (US); Fabian Villalobos, Grand Terrace, CA (US); Andrew Patalano, Moreno Valley, CA (US)

(73) Assignee: The Regents of the University California, Oakland, CA (US)

(21) Appl. No.: 15/745,974

(22) PCT Filed: Jul. 23, 2016
(86) PCT No.: PCT/US2016/043780

§ 371 Date: Jan. 18, 2018

Related U.S. Application Data
(60) Provisional application No. 62/196,007, filed on Jul. 23, 2015.

(51) Int. Cl. C08J 9/28; B01J 20/28; B01J 20/30; C04B 38/00; C08J 9/00; C08L 1/02; C09K 3/32

(52) U.S. Cl. CPC C08J 9/28; B01J 20/28007; B01J 20/28045; B01J 20/3078; C04B 38/0022; C08J 9/0061; C08J 2429/04; C09K 3/32; B01J 2220/4806; B01J 2220/4825; C08J 2201/026; C08J 2201/05; C08J 2205/024; C08L 1/02

(57) ABSTRACT

A method of making a porous material is provided. The method includes: preparing a mixture including a sugar, a polymer, and at least one soluble metal source, in water; heating the mixture to obtain a gelled material; thermally curing the gelled material to obtain a cured material; and annealing at least a part of the cured material to obtain a porous material that includes metal nanoparticles, where the metal nanoparticles include at least one metal from the at least one soluble metal source. The porous material can include: sheets of multilayer graphene layers; metal nanoparticles dispersed among the sheets and encapsulated by layers of graphene; and macropores, mesopores or micropores, or any combination thereof, throughout the porous material and on its surface. Methods of using the porous material to separate contaminants from water are also provided.

### CROSS-REFERENCE TO RELATED APPLICATIONS

This application claims the benefit of Provisional Patent Application No. 62/196,007, filed on Jul. 23, 2015, which is incorporated by reference herein

### STATEMENT REGARDING FEDERALLY SPONSORED RESEARCH OR DEVELOPMENT

This invention was made with Government support under Grant No. DMR0213695 from the National Science Foundation. The Government has certain rights in this invention.

### BACKGROUND

### Field of the Invention

The invention relates to a porous material and methods of preparing and using the material.

### Related Art

In recent years, research converged to develop environmentally and biologically friendly porous structures for different applications such as energy storage (batteries [1]-[6] and capacitors [7]-[9]), environmental cleaning [10]-[14], gas sensing and adsorption [15]-[17], biological [18]-[21], thermal management [22]-[24] and radiation protection and shielding [25], [26]. Carbon-based foams and sponges were found to be significantly promising materials for such applications. Different methods have been foreseen and established to synthesize the 3-D carbon architectures. Most methods are based on using a sacrificial template such as silicon, silicon dioxide, polyurethane (PE), where some are designed solely based on chemical reactions such as sol-gel [23], chemical vapor deposition (CVD) [11] and complex polymerizations [10]. Despite the promising results, the transition of the knowledge and technology from research scale to industry has been affected by the cost and complexity of the synthesis process. For instance, the silicon and silicon dioxide template has to be removed from the structure by severe treatment with hydrofluoric acid (HF) [27]. In many other methods, the precursor materials are expensive and difficult to find. Moreover, the process requires very specific instruments and conditions. Therefore, the stipulation of an inexpensive, easy to fabricate and environmentally friendly structure has been extant.

### SUMMARY

Herein, to overcome the established challenges, we report the synthesis of a novel magnetic hydrophobic porous (including micro, meso and macro porosity) 3-D architecture. To prepare the porous material (also called, graphene sponge, graphite sponge, and carbon foam), a unique polymerization process, followed by annealing at high temperature was designed. The polymerization process allows the formation of different modes of porosity ranging from micron to sub-nanometer and angstrom size. Moreover, the structure is designed to be hydrophobic. Therefore, the natural tendency of the structure is to repel water and absorb non-water based liquids. In this case, this unique structure can be used to separate and filter oil-based contaminants from water. It has to be noted that this graphite sponge is designed to be cheap, scalable, environmentally friendly and reusable.

In one aspect, a method of preparing a porous material is provided. The method includes: preparing a mixture in water, the mixture including a sugar, a polymer having an alcohol moiety, and at least one soluble metal source having an oxidizing anion; heating the mixture to obtain a gelled material; thermally curing the gelled material to obtain a cured material; and annealing at least a part of the cured material to obtain a porous material that includes metal nanoparticles, where the metal nanoparticles include at least one metal from the at least one soluble metal source.

In the method: a) nitric acid or another acid can be added to the mixture before heating, for example, to adjust the pH of the mixture to be acidic or about pH 3; b) the cured material can be cut, milled or ground, prior to annealing; c) the porous material can be hydrophobic or superhydrophobic, oleophilic, ferromagnetic, or any combination thereof; d) the polymer can have one or more primary alcohol and/or secondary alcohol moieties; or e) any combination of a)-d).

In another aspect, a porous material prepared by the method is provided. The porous material includes: sheets of multilayer graphene layers; metal nanoparticles dispersed among the sheets and encapsulated by layers of graphene; and macropores, mesopores or micropores, or any combination thereof, throughout the porous material and on its surface.

The porous material: a) can be hydrophobic or superhydrophobic, oleophilic, ferromagnetic, or any combination thereof; b) can sorb an oil, a non-polar substance, an organic solvent, a toxic contaminant, a corrosive contaminant, or any combination thereof; c) can separate water from the oil, non-polar substance, organic solvent, toxic contaminant, corrosive contaminant, or any combination thereof; or d) can sorb the oil, non-polar substance, organic solvent, toxic contaminant, corrosive contaminant, or any combination thereof, multiple times; e) can be hydrophobic, oleophilic, ferromagnetic, or any combination thereof; or f) any combination of a)-e).

In a further aspect, a method of separating an oil, a non-polar substance, an organic solvent, a toxic contaminant, a corrosive contaminant, or any combination thereof, from water, is provided. The method includes sorbing the oil, non-polar substance, organic solvent, toxic contaminant, corrosive contaminant, or any combination thereof, to the porous material described above. The method can further include: a) removing the porous material from the water; b) collecting the porous material by attracting it with a magnet, wherein the porous material has ferromagnetic properties; c) reusing the porous material to sorb additional oil, non-polar substance, organic solvent, toxic contaminant, corrosive contaminant, or any combination thereof; or d) any combination of a)-c).

### BRIEF DESCRIPTION OF THE DRAWINGS

For a more complete understanding of the present invention, reference is now made to the following descriptions taken in conjunction with the accompanying drawings, in which:

FIG. 1 is a panel showing the separation of toluene from the surface of water (toluene is labeled with oil blue N dye). FIGS. 1(a)-1(c) show the ability of an embodiment of the porous material to act as a filter.

FIG. 2 is a panel showing the separation of chloroform from water. FIGS. 2(a)-2(c) show the removal of chloroform from within water by an embodiment of the porous material.

FIG. 3 is a panel demonstrating the magnetic behavior of an embodiment of a graphite sponge. FIGS. 3(a)-3(c) shows attraction and collection of the embodiment by a magnet.

FIG. 4 is a panel showing the separation of ethanol from water using an embodiment of a magnetic graphite sponge in powder form. FIGS. 4(a)-4(e) show the progressive separation of ethanol from water by the embodiment.

FIG. 5 is a panel providing: 5(a) Raman spectra, and 5(b) X-ray diffraction (XRD) spectra, of an embodiment of a graphite sponge.

FIG. 6 is a graph of pore size distribution vs. differential pore volume of an embodiment of a sponge in powder form.

FIG. 7 is a panel of scanning electron microscopy (SEM) images of an embodiment of a bulk graphite sponge at different magnifications.

FIG. 8 is a panel of scanning electron microscopy (SEM) images of an embodiment of a graphite sponge powder at different magnifications. FIGS. 8(a)-8(c) show cross-sections of the powder.

FIG. 9 is an energy dispersive X-ray spectroscopy (EDS) spectrum of an embodiment of a graphite sponge.

FIG. 10 is a panel of transmission electron microscopy (TEM) images of an embodiment of a graphite sponge at different magnifications. FIGS. 10(a)-10(d) indicate the presence of thin sheets of carbon and metal nanoparticles.

FIG. 11 is a picture of an embodiment of a resin following polymerization.

FIG. 12 is a panel of XRD spectra of an annealed iron-silver graphite sponge (FeAgGS) sample. FIG. 12(a) is an XRD plot; FIG. 12(b) is the same plot characterized with peak matching.

FIG. 13 is a panel of XRD spectra of an annealed copper graphite sponge (CuGS) sample. FIG. 13(a) is an XRD plot; FIG. 13(b) is the same plot characterized with peak matching.

FIG. 14 is a panel of SEM images of an embodiment of a CuGS sample. FIGS. 14(a)-14(c) are images of the sample at various magnifications.

FIG. 15 is a panel of SEM images of a macroporous structure of an embodiment of a CuGS sample. FIGS. 15(a)-15(f) are images of the sample at various magnifications.

FIG. 16 is a panel of SEM images of a macroporous structure from an embodiment of an FeAgGS sample. FIGS. 16(a)-16(c) are images of the sample at various magnifications.

FIG. 17 is a RAMAN spectra of a CuGs sample, an iron graphite sponge (FeGS) sample, and an FeAgGs sample.

### DETAILED DESCRIPTION

In the method of preparing a porous material, the method includes preparing a mixture comprising a sugar, a polymer having an alcohol moiety, and at least one soluble metal source, in water. The method also includes heating the mixture to produce a gelled material, thermally curing the gelled material to produce a cured material, and annealing at least part of the cured material to produce a porous material.

The sugar can be any sugar that has a sugar chain comprising oxidizable terminal carbons. Examples of the sugar include, but are not limited to, sucrose, glucose, fructose, lactose, galactose and maltose.

The polymer can be a polymer having one or more primary alcohol moieties, secondary alcohol moieties, or both primary and secondary alcohol moieties. In some embodiments, the polymer can be a vinyl polymer. A vinyl polymer is a polymer prepared from one or more monomers containing ethenyl groups. Examples of the vinyl polymer include, but are not limited to, polyvinyl alcohol and other polymers containing alcohol groups. Alternatively, the polymer can be a polyhydroxy polymer such as, but not limited to, a polysaccharide such as cellulose.

The metal of the soluble metal source can be any metal such as, but not limited to, iron, copper, silver, nickel, zinc, lithium, vanadium, chromium, titanium, cobalt, manganese, magnesium, aluminum, potassium, sodium, tin, or silicon, or any combination thereof. The soluble metal source can be a metal nitrate or metal halide, for example, including metal halides such as perchlorates, chlorates, chlorites, perbromates, bromites, and the like.

In some embodiments of the method, the sugar is sucrose, the polymer is polyvinyl alcohol, and the metal nitrate is iron nitrate, and nitric acid is added to the mixture before heating.

To produce the gelled material, the mixture can be heated at a temperature in the range of about 90° C. to about 120° C.

Curing can take place at a temperature above the temperature used to produce the gelled material. In some embodiments, the temperature is in the range of about 120° C. to about 150° C., or about 120° C. to about 125° C. The curing can take place under vacuum.

Annealing can take place at a temperature in the range of about 500° C. to about 1000° C., or about 900° C. to about 1000° C. The annealing can occur in an argon and hydrogen atmosphere, a nitrogen and hydrogen atmosphere.

The porous material comprises macropores, mesopores or micropores, or any combination thereof, and metal nanoparticles. Mesopores are pores with a diameter of about 2 to about 50 nm) and micro-pores are pores with a diameter of less than 2 nm. Macropores have diameters of greater than 50 nm.

The metal nanoparticles can be iron, copper, silver, nickel, zinc, lithium, vanadium, chromium, titanium, cobalt, manganese, magnesium, aluminum, potassium, sodium, tin, or silicon nanoparticles, or any combination thereof. Thus, in some embodiments, metal nanoparticles can be iron nanoparticles, copper nanoparticles, or silver nanoparticles, or a combination of iron nanoparticles and silver nanoparticles.

The porous material can be used to decontaminate and/or purify water, remove contaminants and pollutants from water, and separate water from non-water liquids or solutions. Accordingly, the porous material can sorb an oil, a non-polar substance, an organic solvent, a toxic contaminant, a corrosive contaminant, or any combination thereof. Examples of the oil include, but are not limited to, motor oil, diesel oil, pump oil, crude oil, vegetable oil, and cooking oil, and any combination thereof. Examples of the non-polar substance, but are not limited to, toluene and chloroform, and a combination thereof. Examples of the organic solvent include, but are not limited to, toluene and chloroform, and a combination thereof. Examples of the toxic contaminant include, but are not limited to, polycyclic aromatic hydrocarbons (PAHs), polychlorinated biphenyls (PCBs), dibenzanthracenes, and the like, and a combination thereof. Examples of the corrosive contaminant include, but are not limited to, nitrotoluene, naphthalene, phenanthrene, and the like, and any combination thereof. In some embodiments, the solvent contains a dye or stain, and the porous material can sorb the dye or stain along with the solvent. In some embodiments, the sponge can sorb acetone, toluene, chloroform, ethanol, methanol, isopropanol, dimethylformamide, carbon disulfide, any solution of acids and bases in the listed solvents, or used pump or engine oil, or any combination thereof. Any of the oils, non-polar substances, organic solvents, toxic contaminants and corrosive contaminants can be considered contaminants or pollutants.

After sorbing a substance from water, the porous material can be separated from the water by filtering, centrifugation, manual sorting, attraction to a magnetic if the porous material is ferromagnetic, and the like.

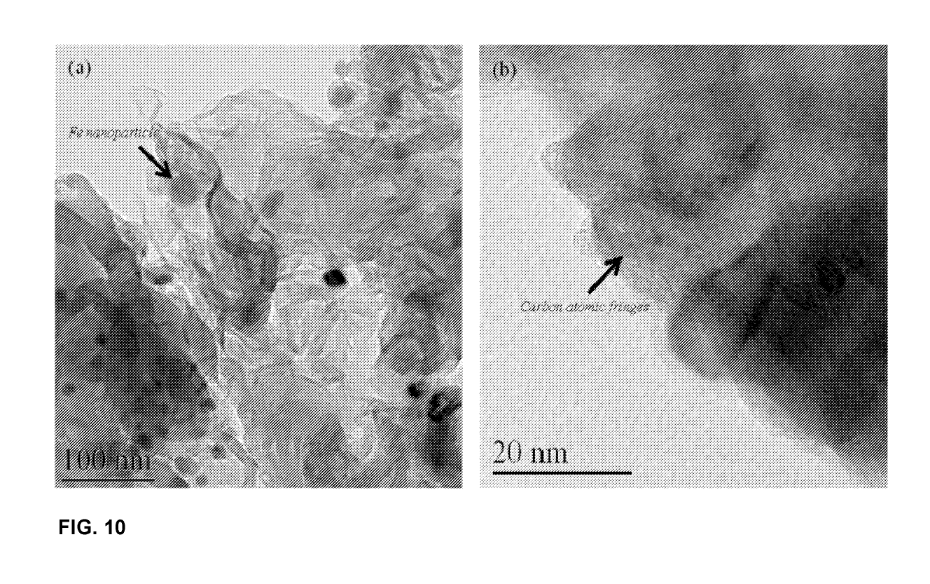

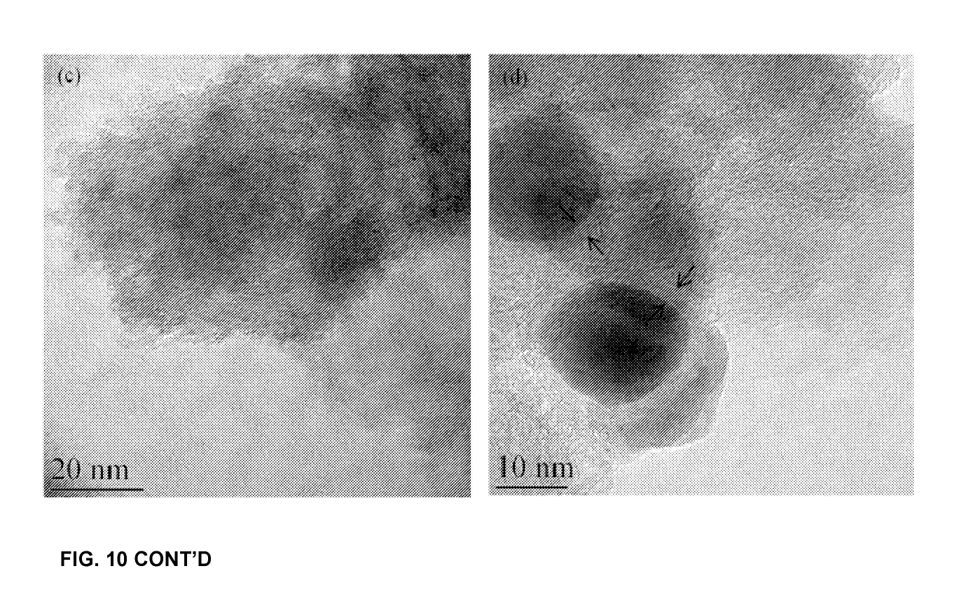

SEM images reveals the microstructure of iron-containing graphite sponge which appears to be a maze of interconnected macropores. Higher magnification SEM shows that the surface of the sponge seems to be very porous and may be considered as possible connected mesopores and channels. Also thin stacks of randomly oriented graphene flakes and layers can be identified on the surface. TEM images reveal that the graphite sponge contains wrinkled and convoluted sheets, also called multilayer graphene layers, as well as dispersed nanoparticles with average diameter of about 20 nm (see FIG. 10(a)). Higher magnification TEM imaging demonstrates that iron nanoparticles are encapsulated within the structure by few layers of graphene (see FIG. 10(d)). HRTEM images show interplanar distances of 0.34 nm which corresponds to the stacking of sp²-hybridized layers of carbon. The structure seems to comprise numerous minuscule graphene domains and randomly oriented flakes which attain a rough microstructure encompassing microchannels (see FIG. 10(c)). HRTEM images resolved from the surface of the sponge indicate the existence of very small graphene-based domains with random orientation and complex stacking as well as sub-nanometer channels separating them. In this sense, the width of the microchannels separating the graphene domains seems to deviate slightly from the measured interplanar distance of 0.34 nm. HRTEM characterization of the graphite sponge reveals that the interconnected porous structure is supported by graphitic walls consisted of about 10-15 graphene-based layers. Moreover, measured interplanar spacing of the stacked layers appeared to conform to that of graphitic structures. The contact angle measurement of water on the sponge was evaluated to be 154.72°, an exceptional hydrophobicity. The sponge offers a remarkable surface area of 823.77 m².g⁻¹ and an average pore diameter of 1.4 nm without chemical activations.

In accordance with some embodiments of the porous materials, graphite sponge materials have been designed to feature a porous, oleophilic graphite structure capable of withdrawing several times their weight in oils and/or nonpolar materials while displaying additional properties caused by metal nanoparticles embedded in the sponge structure. The various properties observed for the final synthesized material depend on the metal nanoparticles chosen during the synthetic process, allowing the overall capabilities of the sponge to be tuned as necessary. Metal nanoparticle examples can include but are not limited to: iron (Fe), copper (Cu), silver (Ag), and nickel (Ni).

Iron graphite sponge (FeGS or FGS) features iron metal nanoparticles and can exhibit magnetic properties as well as the catalytic properties of iron such as ammonia synthesis or carbon nanotube growth. Copper graphite sponge (CuGS or CGS) features copper metal nanoparticles and can exhibit antibacterial and fungicidal properties as well as the catalytic properties of copper such as hydrogenolysis of fatty esters to fatty alcohols including both methyl ester and wax ester processes, alkylation of alcohols with amines, and amination of fatty alcohols. Iron-silver graphite sponge (FeAgGS) features silver metal nanoparticles and can exhibit antibacterial and fungicidal properties as well as the catalytic properties of silver, such as the production of ethylene oxide and formaldehyde, in addition to the catalytic properties described above for iron. Nickel graphite sponge (NGS or NiGS) features nickel metal nanoparticles which can used for anodes and electrodes as well as exhibit the catalytic properties of nickel such as benzene reduction to cyclohexane, or steam reformation of methane to carbon monoxide and hydrogen.

Embodiments of the porous material can be synthesized scalably from sucrose or other sugars, PVA or other polymers, and a predetermined metal nitrate or multiple metal nitrates in water, with or without nitric acid as a catalyst. The resulting resin can be cured by vacuum heating and annealed at high temperatures which also synthesizes metal nanoparticles.

Curing of the resulting resin can take place in a vacuum oven. For example, the vacuum oven can be prepared by connection to a vacuum source and preheating to 125° C. The polymerized resin in the original beaker, for example, can be placed in the vacuum oven and the door is closed. The vacuum oven can then be placed under a vacuum of 25 PSIG. The resin is allowed to cure and expand for at least 6 hours of time. The beaker containing the expanded resin is removed from the oven by depressurizing the oven slowly and carefully removing the hot beaker.

If the cured resin is to be cut, it may be done to generate a desired shape or morphology. If the resin is to be ground into a powder, the resin can be removed from the beaker using a spatula and placed into a mortar. Using a mortar and pestle the resin is pulverized into a fine powder (<200 μm particle size). Grinding can also be accomplished via a ball mill. Selective particle size can be achieved by using sieves for separation.

For annealing, cut or ground resin material can be placed in an alumina crucible, for example. A designated furnace tube is placed in the CVD furnace. The sample in the alumina crucible is placed in the tube and moved as close as possible to the heat source. The furnace is assembled for operation and the internal pressure of the tube is lowered to 10⁻² Torr. The furnace tube is further purged with inert gas (Argon) flowing at 2200 sccm at a pressure of 4 Torr for several minutes. The gas mixture is then changed to a 1:1 mixture of Ar:H₂ and allowed to flow at 200 ccm/min at 4 Torr. The operating temperature of the furnace is raised to 1000° C. over 40 minutes and held at 1000° C. for another 40 minutes before the oven is shut off and allowed to cool. Once the furnace has cooled to lower than 100° C., the tube is repressurized to atmospheric pressure (760 Torr) with Argon and the sample in the alumina crucible is collected. The sponge material sample is recovered from the crucible, weighed and placed in a clean storage container.

In accordance with some embodiments involving iron, the precursors implemented for the synthesis are a sugar, a polymer and a metal compound, which in a particular embodiment are sucrose (sugar), polyvinyl alcohol (PVA) and iron nitrate (Fe(NO₃)₃). The constituents are dissolved in deionized (DI) water according to the determined molar ratios. An addition of an acid, which in this embodiment is about 0.1 ml of nitric acid (HNO₃), can initiate a polymerization process through cross-linking of the modified sucrose molecules and PVA chains. The mixture is then heated up to activate a condensation process and as a result, the metal ions (in this case Fe³⁺) will be accommodated in the forming resin. The viscous resin is then dried and annealed in an inert atmosphere, in this case a nitrogen (N₂) atmosphere, to achieve the final sponge structure. The molar ratios of the metal ions (Fe³⁺) to the PVA monomer and sucrose determine the final properties of the resin and consequently the final sponge structure.

In some embodiments involving iron, the molar ratios of Fe³⁺ ions to sucrose and PVA monomers are maintained at 1:4 and 1:0.7 respectively. About 0.8 g of Fe(NO₃)₃, 0.125 g of PVA and 2.7 g of sucrose are dissolved in 2.5 ml, 2.5 ml and 7 ml of de-ionized water, respectively, and are used as precursors. The polymerization is performed at 90-120° C. under ambient pressure and in air. To adjust the porosity of the precursor prior to final annealing purging argon or nitrogen under vacuum may be applied as well. The polymerized precursor is annealed at vacuum under 1:1 ratio of argon (nitrogen):hydrogen at 600-1000° C. If the microstructure of the polymerized precursor is not acceptable, DI-water may be added to reverse the process and further polymerization can be initiated again. This decreases the amount of waste and increases the efficiency of the method. Any metal ion can be used instead of iron by using a soluble metal source. Tin and silicon containing sponges have been successfully synthesized. Ordinary sugar can be substituted for sucrose and any molecular weights of polyvinyl alcohol can be used as well.

Additionally, the immense surface area can be effortlessly modified to accommodate and attach functionalized groups on the surface. Examples of functionalized groups include, but are not limited to, amines, carboxyls, hydroxyls, pyrenes, carbonyls, epoxides, and the like. Therefore, the applications of this novel structure are not limited to separate non-water contaminants from water but also include water filtration and purification as well as gas sensing and adsorption (for instance to remove CO and CO₂ from the exhaust gasses of the engines). It is crucial to specify that sponge can be fabricated in any desired shape and also can be used in form of powder. By well thought out functionalization of the surface, the structure can be tailored to biological applications such as sensing or separation of a specific biological marker which can be implemented to a wide variety of applications such as military gas masks or highly sensitive biological sensors. The structure contains highly crystalline carbon which is very conductive and can be considered a major breakthrough in the fabrication of integrated sensing platforms.

The present invention may be better understood by referring to the accompanying examples, which are intended for illustration purposes only and should not in any sense be construed as limiting the scope of the invention.

### Example 1

General methods for preparation and analysis of porous material are described.

### Synthesis of the Porous Material

Porous material was prepared by a modified sol-gel process followed by curing in vacuum and annealing at high temperature. Briefly, 2.82 g sucrose (Sigma-Aldrich, >99.5%), 0.12 g polyvinyl alcohol (Sigma-Aldrich, 98-99%) and 0.84 g iron nitrate nonahydrate (Sigma-Aldrich, >98%) were dissolved in 17 ml deionized (DI) water and stirred to form a homogenous solution. 0.1 ml nitric acid (HNO₃) was added to the final solution (sol), and the temperature was then raised up to 90° C. for 1 hour. A viscous dark brown resin (gel) was formed as a result of a series of chemical reactions and polymerization. The resin was cured at 120° C. under vacuum for 2 hours. Then the cured resin was cut into the desired shapes with a blade and transferred into a horizontal tube furnace. The temperature was ramped up with a rate of 10° C.min¹ to the final temperature (500, 600, 700, 800, 900 and 1000° C.). The samples were annealed at 5 torr for 30 minutes in Ar and H₂ atmosphere with the flow rates of 100 and 50 sccm, respectively to form the final sponge structure.

### Absorption Capacity Measurements of Porous Material

To evaluate the kinetic sorption behavior, a 1:1 ratio of deionized (DI) water and contaminant was used. Graphite sponge samples were placed on the surface of water and weighed at different times upon absorption. The measurements continued until a plateau of weight change was achieved. Each set of measurements repeated eight times.

To measure the absolute absorption capacity, graphite sponge samples were submerged in a container of contaminant and sonicated for 10 minutes. Each set of measurements repeated 8 times.

### Materials Characterization

The morphology investigation and imaging analysis were performed using scanning electron microscope (SEM; FIB NNS450) equipped with X-ray energy dispersive spectroscopy (EDS) and transmission electron microscope (TEM; Philips, CM300) with a LaB₆ cathode operated at 300 KV. For TEM imaging, the pulverized sponge was dispersed ultrasonically in ethanol for 1 hour, and a diluted sample was drop casted on the carbon-coated TEM grid. Crystal structure and phase identification was done by X-ray diffraction analysis (XRD, Philips X′Pert) using Cu Kα radiation. Raman spectrum was collected using a Horiba LabRAIVI HR spectrometer and an excitation source with wavelength of 532 nm. Fourier transform infrared spectroscopy was carried out using a Bruker Equinox 55 FTIR. The surface area and pore size distribution analysis were accomplished by means of Brunauer-Emmett-Teller (BET) measurements using Micromeritics ASAP 2020 with nitrogen gas. Magnetic properties were measured using a vibrating sample magnetometer (VSM).

### Example 2

Embodiments were prepared from sucrose (sugar), polyvinyl alcohol (PVA) and iron nitrate (Fe(NO₃)₃) similar to Example 1, to produce an iron-containing graphite sponge.

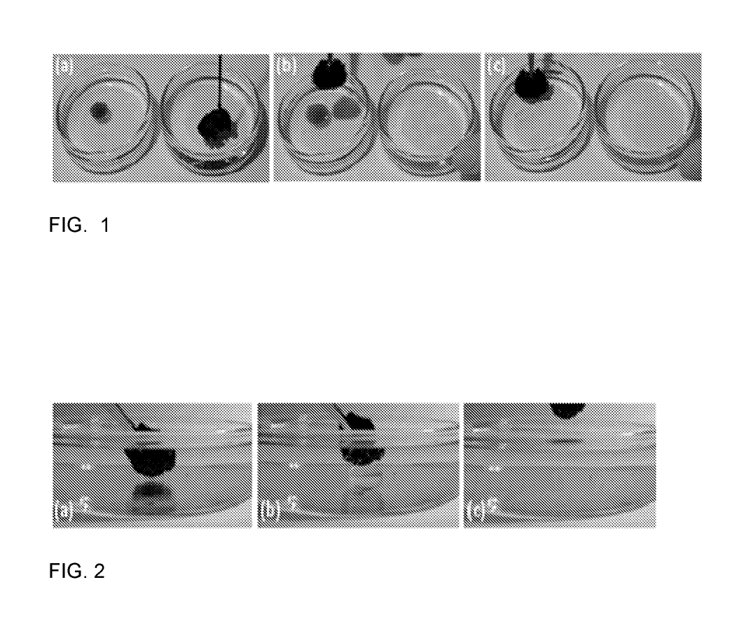

FIG. 1 demonstrates the removal of toluene from the surface of water using the graphite sponge. A droplet of toluene labeled with oil blue N dye has been applied to the left petri dish. Then the graphite sponge in the right petri dish has been soaked with five droplets of toluene (FIG. 1(a)). Results confirm that the graphite sponge acted as a filter, not allowing any contamination through to the water in the right container, and it still can be used to clean the contamination from the surface of water in the left container (FIGS. 1(b) and 1(c)).

We have also examined the sponge to remove chloroform from water (FIGS. 2(a)-2(c)). The results suggest that the graphite sponge can be used to remove the contaminants within any depth from water. It is essential to point out that the sponge is significantly capable to absorb liquid contaminants with different densities (heavier or lighter that water).

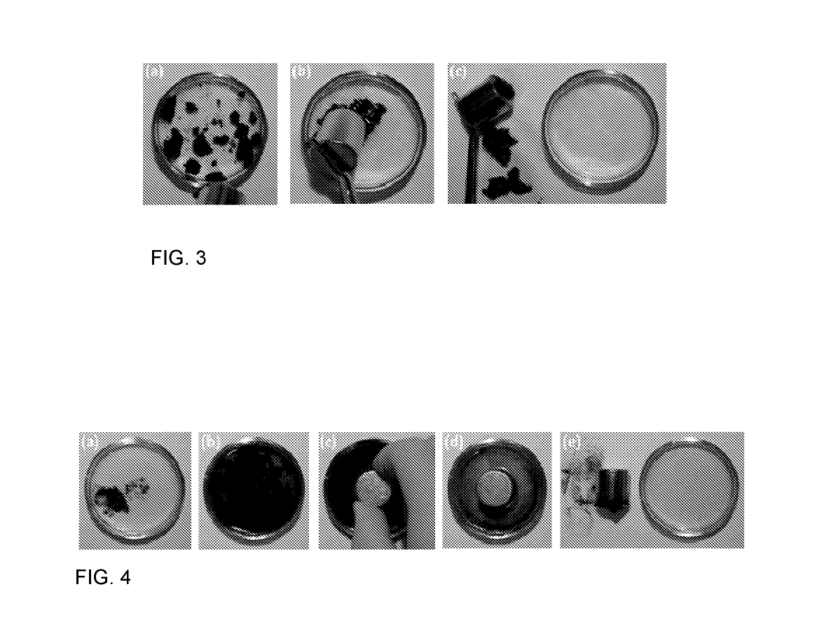

The iron nanoparticles embedded inside the sponge are found to be α-Fe phase which under the Curie temperature will be ferromagnetic. Therefore, the sponge will demonstrate soft magnetic properties in presence of a magnet. By using a magnet, collecting or guiding the sponge pieces is conceivable. As shown in FIGS. 3(a), 3(b) and 3(c), the sponge is attracted, attached and collected using the magnet.

In a similar experiment, the sponge was ground to obtain a very fine powder and then used to assess the potential of the sponge to absorb contaminants as well as being collected easily by a magnet. Surprisingly, we found that the sponge absorbs ethanol about 20 times of its weight when used in form of solid pieces and the ethanol absorbace will be about 50 times its weight when the sponge is implemented in powder form. FIG. 4, shows the snap shots of the experiment when the sponge in form of a powder is mixed with a mixture of water and ethanol (FIGS. 4(a) and (b)). The ethanol was dyed with rhodamine b which provides a pink color for ethanol in the mixture. A magnet is placed in the container and the sponge powder, which now contains the absorbed ethanol, is gradually collected from water (FIGS. 4(c) and (d)). FIG. 4(e) confirms that the sponge powder effectively separated ethanol from water and is collected by the magnet from decontaminated water.

To further characterize the structure, Raman spectroscopy, powder X-ray diffraction (XRD) and Brunauer-Emmett-Teller (BET) analyses have been carried out on the graphite sponge to evaluate the properties such as crystallinity, average crystallite size, atomic structure and the surface area as well as the pore size distribution).

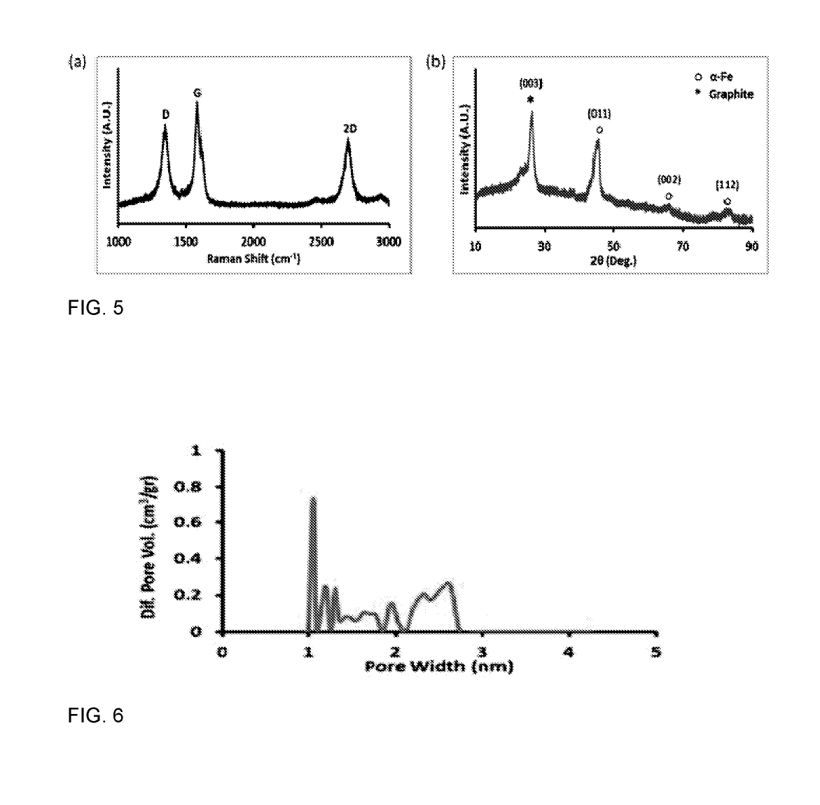

Raman spectra of the graphite sponge is demonstrated in FIG. 5(a). The presence of D, G and 2D peaks in the spectra which are characteristic peaks representing graphene, confirms that the sponge structure is consisted of graphene based sheets. The ratio of the characteristic peaks also suggested that the graphene is most likely to be multi-layer raging from about 5 to about 25 layers.

X-ray diffraction analysis of the graphite sponge powder suggests that the structure is highly crystalline and mostly consists of thick graphene (thin graphene-based sheets) as well as α-Fe which is considered a ferromagnetic phase bellow its Curie temperature (771° C.). The presence of the magnetic phase of iron justifies the magnetic behavior of the sponge. All identified phases are labeled in the XRD spectra of the structure (FIG. 5(b)). The average crystallite size of iron nanoparticles is calculated to be about 30 nm, using the Debye-Scherrer equation and the sponge powder XRD data.

FIG. 6 displays the pore size distribution vs. the differential pore volume for the graphite sponge. The results indicate that the sponge contains mostly meso-pores (pores with diameter of 2-50 nm) and micro-pores (pores with diameter less than 2 nm). However, the sponge powder was used for the BET measurement and as a result no macro-pores where being detected. Considering the multi modal porosity of the sponge, the presented active surface area of the structure is considerably high.

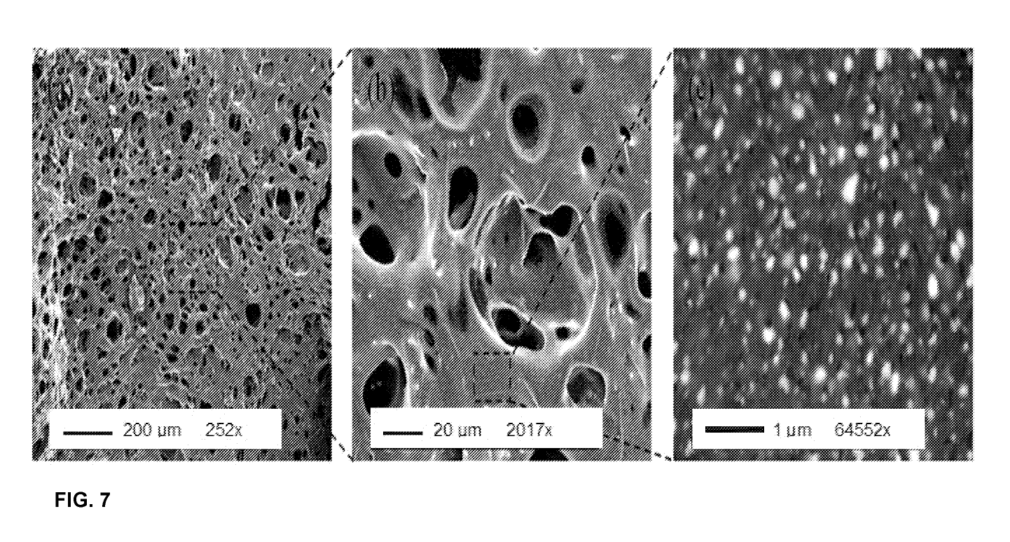

FIG. 7 illustrates the Scanning Electron Microscopy (SEM) images of the bulk graphite sponge at different magnifications and confirms the presence of macro-pores as well as the high porosity of the structure. Furthermore, the iron nanoparticles can be identified in the structure as well. The SEM images suggest that the iron nanoparticles are distributed mostly on the surface, however, the transmission electron microscopy (TEM) images prove that the iron nanoparticles are formed everywhere in the structure and are encapsulated in multi-layer graphene-based sheets.

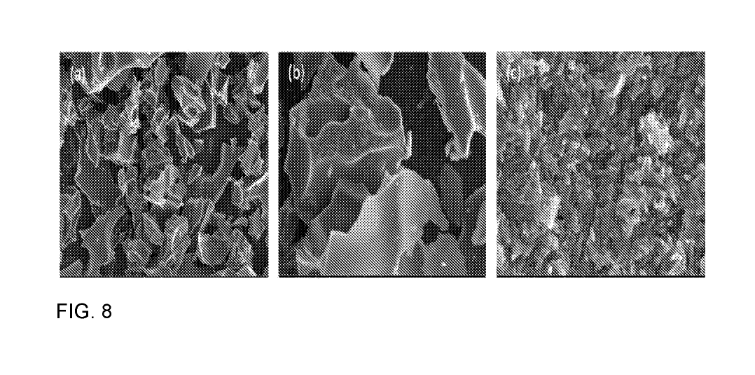

FIG. 8 demonstrated the SEM images of the sponge in form of powder (after grinding). It seems that by grinding process, the cross-section of the structure seems to have a very rough and porous surface (FIGS. 8(a) and 8(b)). This observation explains the difference in the absorbance capacity of the sponge in form of bulk and powder, which has been discussed before. FIG. 8(c) shows the iron nanoparticles in the cross-section of the sponge which confirms that the nanoparticles are dispersed everywhere in the structure.

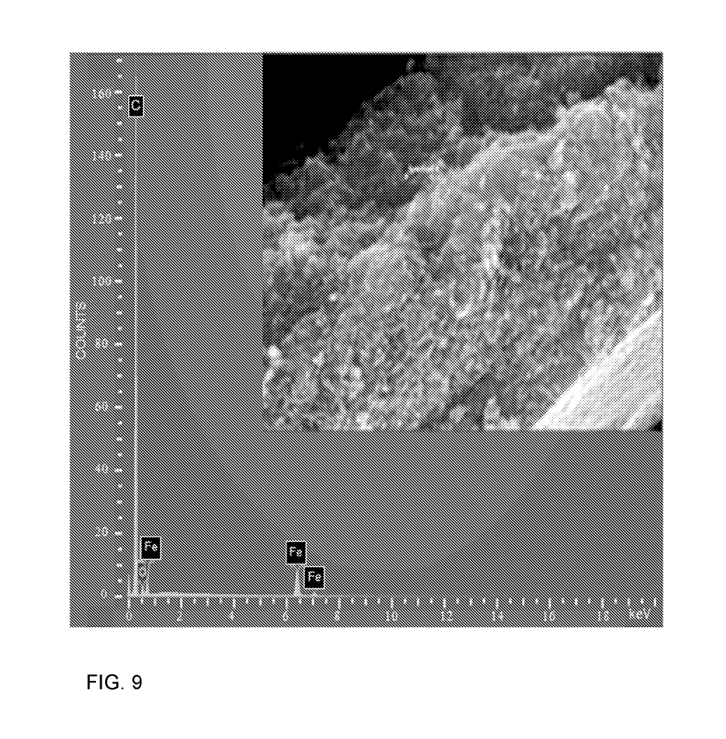

Energy dispersive X-ray spectroscopy (EDS) has been performed on the cross-section of the sponge and the results suggest that the structure contains about 12.69 wt % iron which has been identified as α-Fe. FIG. 9 displays the EDS spectra of the cross-section of the sponge.

Finally to confirm and verify the data acquired from XRD, Raman spectroscopy, BET, SEM and EDS analyses, transmission electron microscopy (TEM) is carried out on the graphite sponge structure. FIG. 10(a) illustrates that the sponge is consisted of thin sheets of carbon and dispersed iron nanoparticles in between the graphene-based sheets. The atomic fringes of carbon can be recognized in FIG. 10(b) which explains the high crystallinity of the sponge structure. In addition, the surface roughness can be identified as a series of highly crystalline graphene-based sheets which are interlocked with each other on the surface of the structure (FIG. 10(c)). Finally, FIG. 10(d) confirms that the iron nanoparticles are embedded in the sponge and encapsulated with about 5-10 layers of graphene-based sheets.

To conclude, the advantages of this novel structure over the existing technologies are: the superior porosity (we have tailored the structure to have multi-modal porosity), cost effectiveness and ease of fabrication (the structure was designed to be fabricated from cheap and abundant precursors), environmental friendliness (the sponge is pure carbon after processing and all contaminants can be removed by heat treatment at relatively low temperatures) and scalability (it can be fabricated in kilogram scale in a laboratory and it does not require expensive set up and equipment). Besides, our cycling absorbance experiments indicated the substantial cyclability of the sponge since no fading has been observed in the absorbance capacity after 20 cycles.

### Example 3

Embodiments were prepared with copper nitrate, or iron nitrate and silver nitrate, as the metal nitrate to prepare copper-containing or iron and silver-containing graphite sponges.

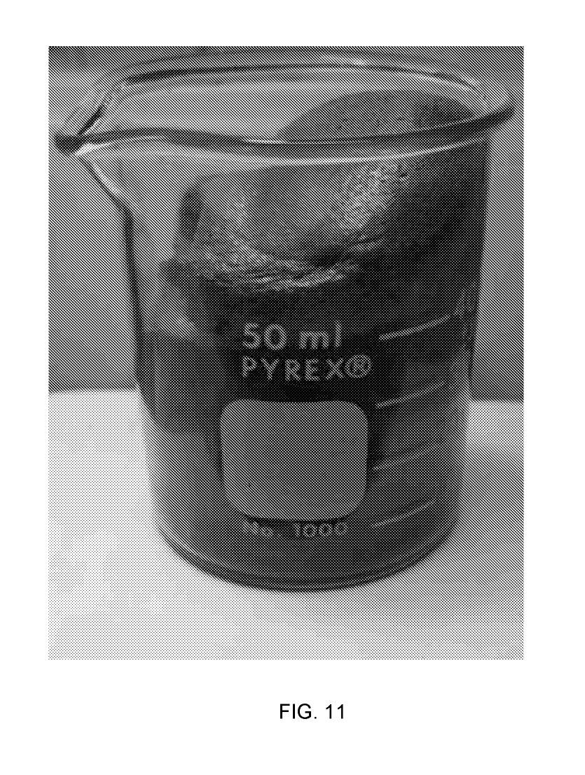

For example, an amount of 1 molar equivalent of a predetermined metal nitrate is weighed and placed into a glass beaker with a stir bar. To the same beaker, 1 molar equivalent of sucrose and 0.000343 molar equivalents of PVA are added. For polymerization, the reagents are dissolved in DI water and heated to 90° C. while stirring. In less than 24 hours the polymerization process forms a thick resin. The beaker containing the resin is removed from the stir plate, as seen in FIG. 11.

For curing, the vacuum oven can be prepared by connection to a vacuum source and preheating to 125° C. The polymerized resin in the original beaker, can be placed in the vacuum oven and the door is closed. The vacuum oven can then be placed under a vacuum of 25 PSIG. The resin is allowed to cure and expand for at least 6 hours of time. The beaker containing the expanded resin is removed from the oven by depressurizing the oven slowly and carefully removing the hot beaker.

For annealing, a designated furnace tube is placed in the CVD furnace. The sample in an alumina crucible is placed in the tube and moved as close as possible to the heat source. The furnace is assembled for operation and the internal pressure of the tube is lowered to 10⁻² Torr. The furnace tube is further purged with inert gas (Argon) flowing at 2200 sccm at a pressure of 4 Torr for several minutes. The gas mixture is then changed to a 1:1 mixture of Ar:H₂ and allowed to flow at 200 ccm/min at 4 Torr. The operating temperature of the furnace is raised to 1000° C. over 40 minutes and held at 1000° C. for another 40 minutes before the oven is shut off and allowed to cool. Once the furnace has cooled to lower than 100° C., the tube is repressurized to atmospheric pressure (760 Torr) with Argon and the sample in the alumina crucible is collected. The sponge material sample is placed in a clean storage container.

### Results

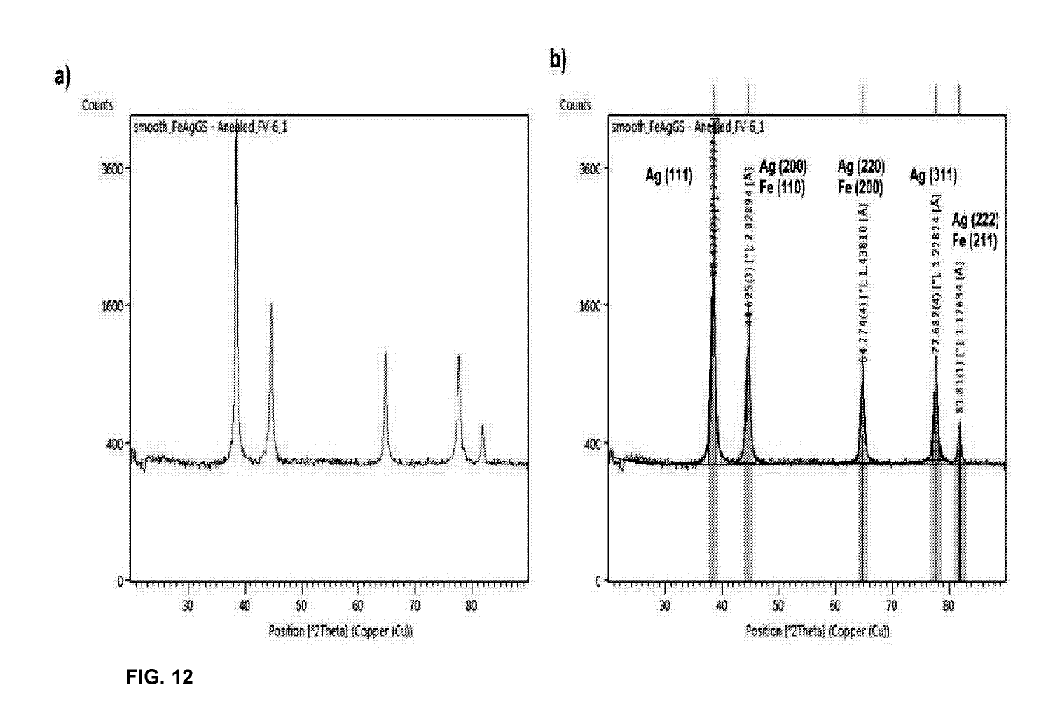

FIG. 12 shows XRD spectra for an FeAgGS sample. FIG. 12(a) shows a background subtracted, low pass smoothed XRD plot taken from the annealed FeAgGS sample. FIG. 12(b) shows the same XRD plot as in FIG. 12(a) but characterized using peak matching in Highscore software (ICSD Ref: 01-071-4613, 01-085-1410). The XRD spectra show matching reflections for silver at: 38.47° (111), 44.62° (200), 64.77° (220), 77.68° (311), and 81.81° (222). Reflections matching iron were also seen at: 44.62° (110), 64.77° (200), and 81.81° (211).

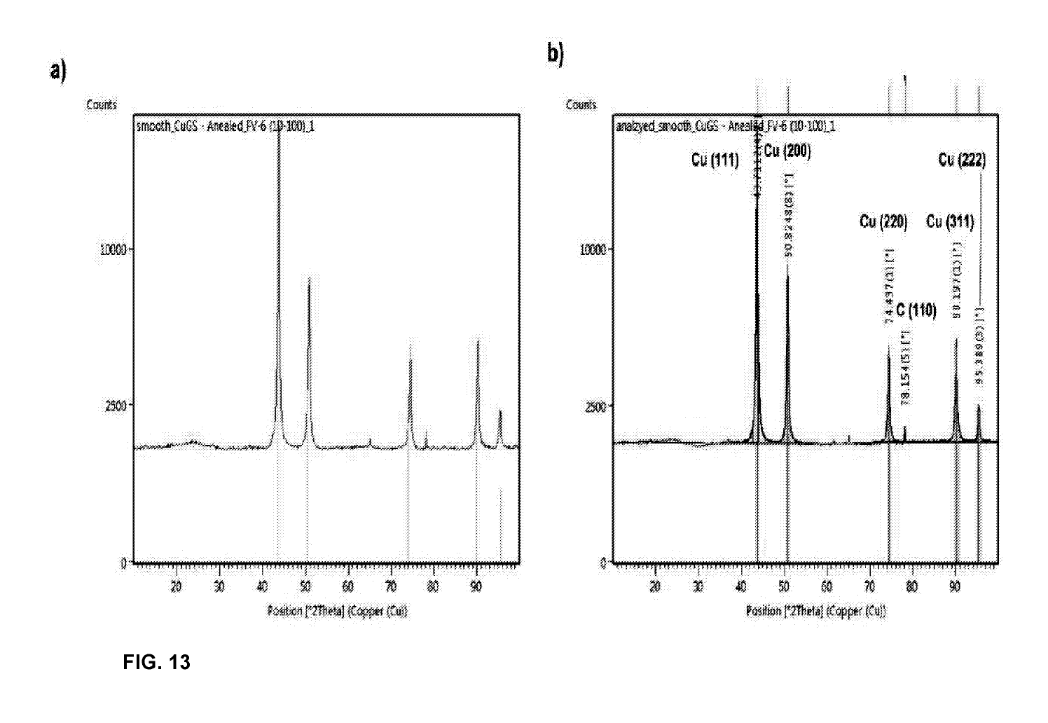

FIG. 13 shows XRD spectra for a CuGS sample. FIG. 13(a) shows a background subtracted, low pass smoothed XRD plot taken from the annealed CuGS sample. FIG. 13(b) shows the same XRD plot as in FIG. 13(a) but characterized using peak matching in Highscore software (ICSD Ref: 01-074-5799, 01-075-2078). The XRD spectra shows matching reflections for copper at 43.71° (111), 50.82° (200), 74.43° (220), 90.19° (311), and 95.38° (222). Another peak shown at 78.15° corresponds to the carbon (110) reflection.

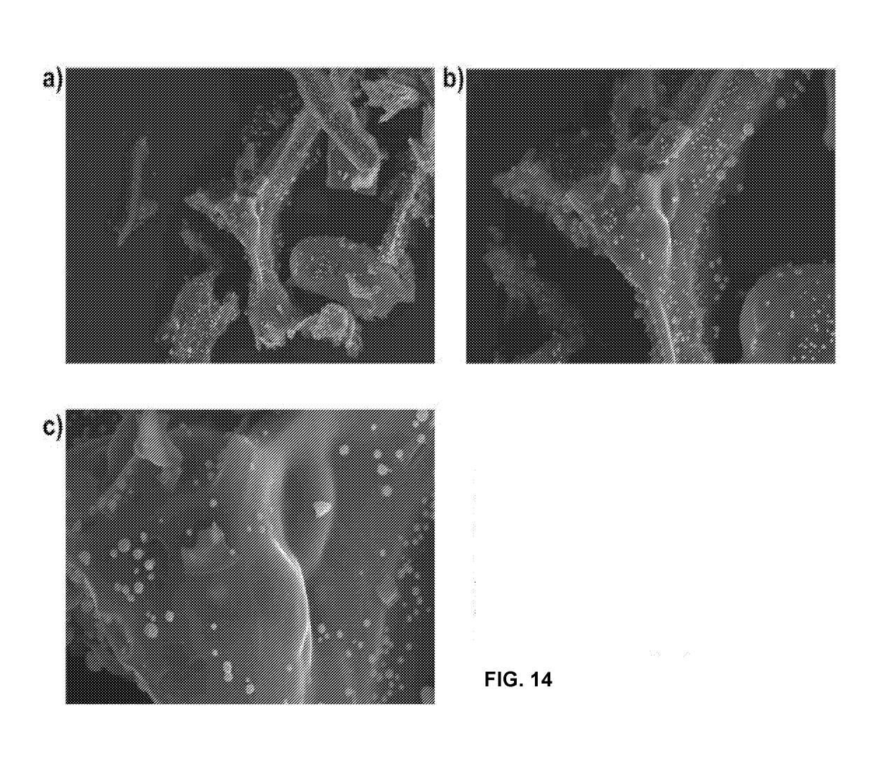

FIG. 14 shows SEM images of a CuGS sample at various magnifications. FIG. 14(a) shows a particle fractured from a larger macroporous structure. FIGS. 14(b) and 14(c) show magnified portions of the same particle, where mesopores can be seen along with copper particles on the surface and imbedded within the sponge.

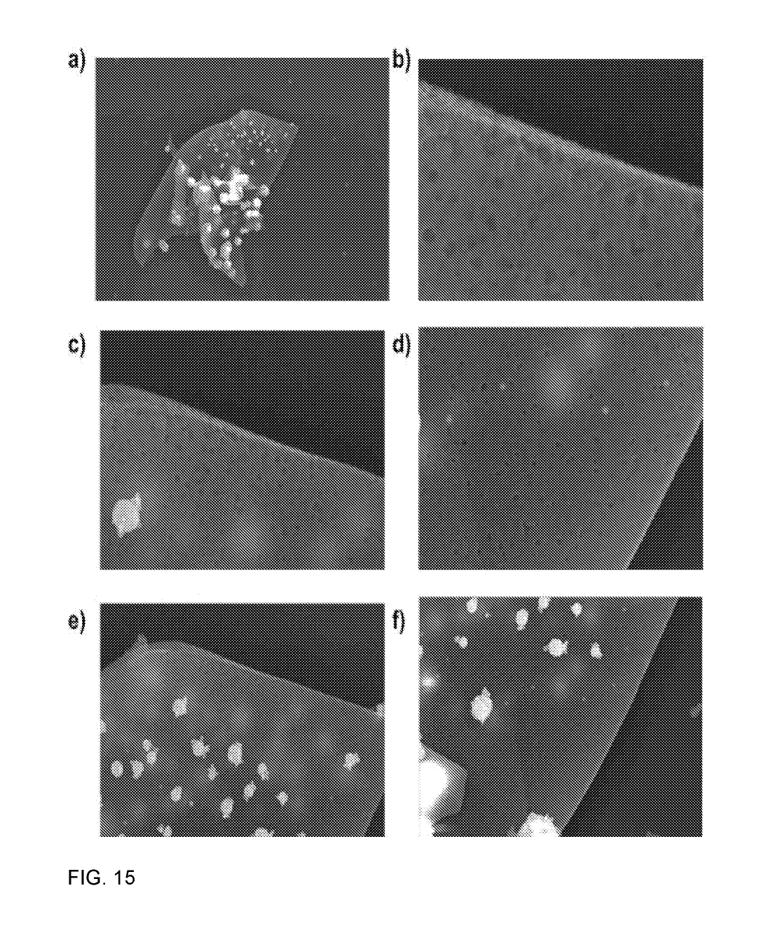

FIG. 15 shows SEM images of a CuGS sample at various magnifications. FIG. 15(a) shows a particle fractured from a larger macroporous structure. FIGS. 15(a)-15(f) show magnified portions of the same particle, where mesopores can be seen along with copper particles on the surface and imbedded with the sponge.

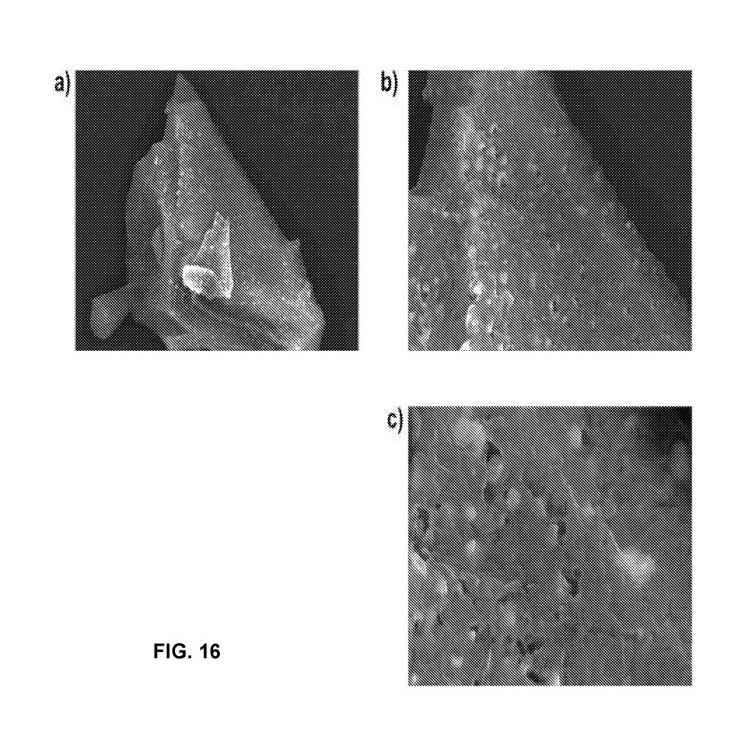

FIG. 16 shows SEM images of an FeAgGS sample at various magnifications. FIG. 16(a) shows a particle fractured from a larger macroporous structure. FIGS. 16(b) and 16(c) show magnified portions of the same particle, where mesopores can be seen along with silver and iron particles on the surface and imbedded within the sponge.

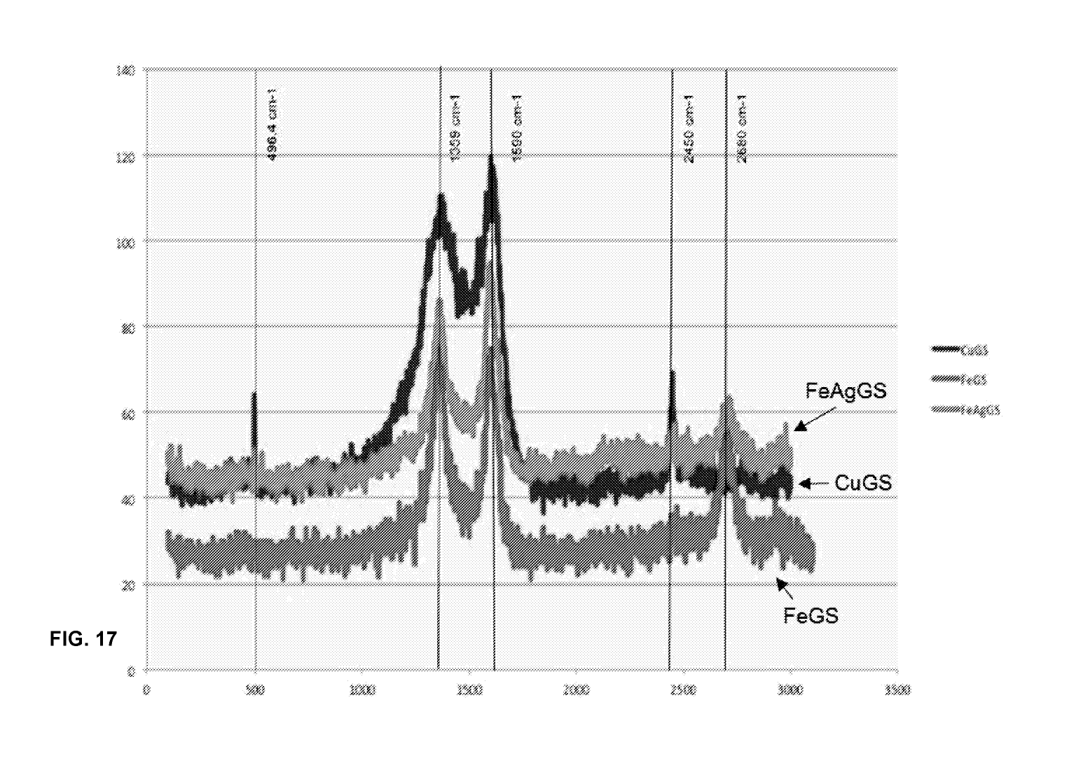

FIG. 17 shows Raman spectra for CuGS, FeGS and FeAgGS samples.

### REFERENCES

The following publications are incorporated by reference herein in their entirety:
[1] J. Zhang, J. Xiang, Z. Dong, Y. Liu, Y. Wu, C. Xu, and G. Du, “Biomass derived activated carbon with 3D connected architecture for rechargeable lithium-sulfur batteries,” Electrochim. Acta, vol. 116, pp. 146-151, January 2014.
[2] X. Yang, P. He, and Y. Xia, “Preparation of mesocellular carbon foam and its application for lithium/oxygen battery,” Electrochem. commun., vol. 11, no. 6, pp. 1127-1130, June 2009.
[3] Y. Wang, Y. Wang, E. Hosono, K. Wang, and H. Zhou, “The design of a LiFePO4/carbon nanocomposite with a core-shell structure and its synthesis by an in situ polymerization restriction method.,” Angewandte Chemie (International ed. in English), vol. 47, no. 39. pp. 7461-5, January-2008.
[4] X. Tao, X. Chen, Y. Xia, H. Huang, Y. Gan, R. Wu, F. Chen, and W. Zhang, “Highly mesoporous carbon foams synthesized by a facile, cost-effective and template-free Pechini method for advanced lithium-sulfur batteries,” J. Mater. Chem. A, vol. 1, no. 10, p. 3295, 2013.
[5] H. Ji, L. Zhang, M. T. Pettes, H. Li, S. Chen, L. Shi, R. Piner, and R. S. Ruoff, “for Battery Electrodes,” pp. 8-13, 2012.
[6] H. D. Asfaw, M. R. Roberts, C.-W. Tai, R. Younesi, M. Valvo, L. Nyholm, and K. Edström, “Nanosized LiFePO4-decorated emulsion-templated carbon foam for 3D micro batteries: a study of structure and electrochemical performance.,” Nanoscale, vol. 6, no. 15, pp. 8804-13, July 2014.
[7] D. a. C. Brownson, L. C. S. Figueiredo-Filho, X. Ji, M. Gomez-Mingot, J. Iniesta, O. Fatibello-Filho, D. K. Kampouris, and C. E. Banks, “Freestanding three-dimensional graphene foam gives rise to beneficial electrochemical signatures within non-aqueous media,” J. Mater. Chem. A, vol. 1, no. 19, p. 5962, 2013.
[8] Z. Fan, D. Qi, Y. Xiao, J. Yan, and T. Wei, “One-step synthesis of biomass-derived porous carbon foam for high performance supercapacitors,” Mater. Lett., vol. 101, pp. 29-32, June 2013.
[9] E. C. S. Transactions and T. E. Society, “Development and Evaluation of an Asymmetric Capacitor with a Nickel/Carbon Foam Positive Electrode B. C. Cornilsen,” vol. 50, no. 43, pp. 135-143, 2013.
[10] P. Calcagnile, D. Fragouli, I. S. Bayer, G. C. Anyfantis, L. Martiradonna, P. D. Cozzoli, R. Cingolani, and A. Athanassiou, “Magnetically driven floating foams for the removal of oil contaminants from water.,” ACS Nano, vol. 6, no. 6, pp. 5413-9, June 2012.
[11] X. Dong, J. Chen, Y. Ma, J. Wang, M. B. Chan-Park, X. Liu, L. Wang, W. Huang, and P. Chen, “Superhydrophobic and superoleophilic hybrid foam of graphene and carbon nanotube for selective removal of oils or organic solvents from the surface of water.,” Chem. Commun. (Camb)., vol. 48, no. 86, pp. 10660-2, November 2012.
[12] P. Thanikaivelan, N. T. Narayanan, B. K. Pradhan, and P. M. Ajayan, “Collagen based magnetic nanocomposites for oil removal applications.,” Sci. Rep., vol. 2, p. 230, January 2012.
[13] D. D. Nguyen, N.-H. Tai, S.-B. Lee, and W.-S. Kuo, “Superhydrophobic and superoleophilic properties of graphene-based sponges fabricated using a facile dip coating method,” Energy Environ. Sci., vol. 5, no. 7, p. 7908, 2012.
[14] X. Zhang, Z. Li, K. Liu, and L. Jiang, “Bioinspired Multifunctional Foam with Self-Cleaning and Oil/Water Separation,” Adv. Funct. Mater., vol. 23, no. 22, pp. 2881-2886, June 2013.
[15] L. Li, M. Liu, S. He, and W. Chen, “Freestanding 3D Mesoporous Co3O4@ Carbon Foam Nanostructures for Ethanol Gas Sensing.,” Anal. Chem., July 2014.
[16] R. Narasimman, S. Vijayan, and K. Prabhakaran, “Carbon foam with microporous cell wall and strut for CO2 capture,” RSC Adv., vol. 4, no. 2, p. 578, 2014.
[17] V. K. Saini, M. L. Pinto, and J. Pires, “Synthesis and adsorption properties of micro/mesoporous carbon-foams prepared from foam-shaped sacrificial templates,” Mater. Chem. Phys., vol. 138, no. 2-3, pp. 877-885, March 2013.
[18] D. Lee, J. Lee, J. Kim, J. Kim, H. B. Na, B. Kim, C.-H. Shin, J. H. Kwak, a. Dohnalkova, J. W. Grate, T. Hyeon, and H.-S. Kim, “Simple Fabrication of a Highly Sensitive and Fast Glucose Biosensor Using Enzymes Immobilized in Mesocellular Carbon Foam,” Adv. Mater., vol. 17, no. 23, pp. 2828-2833, December 2005.
[19] J. Lee, D. Lee, E. Oh, J. Kim, Y.-P. Kim, S. Jin, H.-S. Kim, Y. Hwang, J. H. Kwak, J.-G. Park, C.-H. Shin, J. Kim, and T. Hyeon, “Preparation of a Magnetically Switchable Bio-electrocatalytic System Employing Cross-linked Enzyme Aggregates in Magnetic Mesocellular Carbon Foam,” Angew. Chemie, vol. 117, no. 45, pp. 7593-7598, November 2005.
[20] L. Zhang, H. Li, K. Li, S. Zhang, J. Lu, W. Li, S. Cao, and B. Wang, “Carbon foam/hydroxyapatite coating for carbon/carbon composites: Microstructure and biocompatibility,” Appl. Surf. Sci., vol. 286, pp. 421-427, December 2013.
[21] D. Lin, J. Wu, H. Ju, and F. Yan, “Nanogold/mesoporous carbon foam-mediated silver enhancement for graphene-enhanced electrochemical immunosensing of carcinoembryonic antigen.,” Biosens. Bioelectron., vol. 52, pp. 153-8, February 2014.
[22] N. C. Gallego and J. W. Klett, “C arbon foams for thermal management,” vol. 41, no. January, pp. 1461-1466, 2003.
[23] X. He, Z. Tang, Y. Zhu, and J. Yang, “Fabrication of carbon foams with low thermal conductivity using the protein foaming method,” Mater. Lett., vol. 94, pp. 55-57, March 2013.
[24] Q. Lin, B. Luo, L. Qu, C. Fang, and Z. Chen, “Direct preparation of carbon foam by pyrolysis of cyanate ester resin at ambient pressure,” J. Anal. Appl. Pyrolysis, vol. 104, pp. 714-717, November 2013.
[25] R. Kumar, a. P. Singh, M. Chand, R. P. Pant, R. K. Kotnala, S. K. Dhawan, R. B. Mathur, and S. R. Dhakate, “Improved microwave absorption in lightweight resin-based carbon foam by decorating with magnetic and dielectric nanoparticles,” RSC Adv., vol. 4, no. 45, p. 23476, 2014.
[26] R. Kumar, S. R. Dhakate, P. Saini, and R. B. Mathur, “Improved electromagnetic interference shielding effectiveness of light weight carbon foam by ferrocene accumulation,” RSC Adv., vol. 3, no. 13, p. 4145, 2013.
[27] V. A. Online, “Facile synthesis and application of a carbon foam with large mesopores †,” pp. 19134-19137, 2013.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims.

What is claimed is:

1. A method of preparing a porous material, comprising
preparing a mixture in water, the mixture comprising a sugar, a polymer comprising an alcohol moiety, and at least one soluble metal source comprising an oxidizing anion;
heating the mixture to obtain a gelled material;
thermally curing the gelled material to obtain a cured material; and
annealing at least a part of the cured material to obtain a porous material comprising metal nanoparticles, wherein the metal nanoparticles comprise at least one metal from the at least one soluble metal source.

2. The method of claim 1, wherein nitric acid is added to the mixture before heating.

3. The method of claim 1, wherein the cured material is cut, milled or ground, prior to annealing.

4. The method of claim 1, wherein the sugar is sucrose, glucose, fructose, lactose, galactose or maltose.

5. The method of claim 1, wherein the polymer is polyvinyl alcohol or cellulose.

6. The method of claim 1, wherein the metal of the soluble metal source is iron, copper, silver, nickel, zinc, lithium, vanadium, chromium, titanium, cobalt, manganese, magnesium, aluminum, potassium, sodium, tin, or silicon, or any combination thereof.

7. The method of claim 1, wherein the sugar is sucrose, the polymer is polyvinyl alcohol, and the soluble metal source is iron nitrate, and nitric acid is added to the mixture before heating.

8. A porous material prepared by the method of claim 1.

9. A porous material comprising
sheets of multilayer graphene layers,
metal nanoparticles dispersed among the sheets and encapsulated by layers of graphene, and
macropores, mesopores or micropores, or any combination thereof, throughout the porous material and on its surface.

10. The porous material of claim 9, wherein the metal nanoparticles are iron, copper, silver, nickel, tin, or silicon nanoparticles, or any combination thereof.

11. The porous material of claim 10, wherein the metal nanoparticles are iron, copper, or silver nanoparticles, or a combination of iron nanoparticles and silver nanoparticles.

12. The porous material of claim 9, wherein the porous material can sorb an oil, a non-polar substance, an organic solvent, toxic contaminant, corrosive contaminant, or any combination thereof.

13. The porous material of claim 12, wherein the porous material can separate water from the oil, non-polar substance, organic solvent, toxic contaminant, corrosive contaminant, or any combination thereof.

14. The porous material of claim 12, wherein the porous material can sorb the oil, non-polar substance, organic solvent, toxic contaminant, corrosive contaminant, or any combination thereof, multiple times.

15. The porous material of claim 9, wherein the material is hydrophobic, oleophilic, ferromagnetic, or any combination thereof.

16. A method of separating an oil, a non-polar substance, an organic solvent, or any combination thereof, from water, comprising sorbing the oil, non-polar substance, organic solvent, toxic contaminant, corrosive contaminant, or any combination thereof, to the porous material of claim 9.

17. The method of claim 16, further comprising collecting the porous material by attracting it with a magnet, wherein the porous material has ferromagnetic properties.

18. The method of claim 16, further comprising reusing the porous material to sorb additional oil, non-polar substance, organic solvent, toxic contaminant, corrosive contaminant, or any combination thereof.
